(19) United States
(12) Patent Application Publication
(10) Pub. No.: US 2007/0134455 A1
(43) Pub. Date: Jun. 14, 2007

(54) Method for the manufacture of parts made of a synthetic material and having a hollow annular section and part thus obtained

(76) Inventor: Jean-Luc Dreyer, Barr (FR)

Correspondence Address: YOUNG & THOMPSON, 745 SOUTH 23RD STREET, 2ND FLOOR, ARLINGTON, VA, 22202, US

(21) Appl. No.: 10/577,467

(22) PCT Filed: Oct. 27, 2003
(86) PCT No.: PCT/FR03/03187

§ 371 Date: Sep. 27, 2006

(51) Int. Cl. B29D 22/00; B32B 27/08

(52) U.S. Cl. 428/35.7; 264/572; 428/66.6

(57) ABSTRACT

The invention relates to a method for the manufacture of parts which are made of a synthetic material and which have a hollow annular section, said parts being manufactured by prior injection of melted synthetic material into a mold, followed by injection of a pressurized fluid in order to force the melted material against the walls of the mold, finishing the filling of the mold. The invention also relates to the part thus obtained. The method is characterized in that it essentially consists in injecting melted synthetic material at the level of a nose or hub (3) by means of an opening in the mold, and in injecting a fluid close to the nose or hub (3) by means of at least one opening enabling a guiding zone (10) to be created for the axis of rotation. The invention can more particularly be applied to the production of hollow parts made of a synthetic material by injection.

The present invention relates to the field of production of hollow pieces of synthetic material, by injection, in particular wheel, steering wheels and all other hollow pieces forming a circular ring or not, and has for its object a process for production of such an annular piece of hollow cross-section.

The invention also has for its object an annular piece of hollow cross-section obtained by the practice of this process.

The production of this type of piece is in accordance with technical specifications taking into account the forces that the piece must resist, as well as the aesthetic criteria that is must observe. Thus, to take account of the need for sturdiness, it is generally provided to provide a region of large cross-section, which can then be covered with a soft material adapted to absorb shock and hence noise. The production of a piece of large thick cross-section however requires the production of two half-shells which are assembled ultimately with each other by welding or cementing.

The production of pieces of synthetic material with a thick wall or very thick wall however has numerous drawbacks due to the particularity that a synthetic material has poor thermal conductivity, such that the obtained pieces are very difficult to cool over large thicknesses. This results from the following equation permitting determining the time t necessary for a piece to be ejected at a mean temperature Td:
in which:

$$t = \frac{{S}^{2}}{α \cdot π } \cdot [ ln ( \frac{4}{π} \cdot \frac{Ti - Tm}{Td - Tm} ) ]$$

s=thickness of the piece

$$α = \frac{λ}{Cp \cdot ρ}$$

λ=thermal conductivity

Cp=specific heat

ρ=mass volume

Ti=temperature of injection

Tm=wall temperature

Td=temperature of unmolding

So as to obtain economically acceptable cycle times, a piece of synthetic material must have a wall thickness as thin as possible. Thus, for example, a production of an annular piece of large cross-section is not economically realistic.

As a result, in cases in which a certain appearance must be maintained, it has been necessary to use different processes for production, each having its own advantages and disadvantages.

By way of example, the hollow wheels of children's tricycles are generally made according to a rotor-molding technique consisting in rotation and heating. There results a flow of the melted material along the wall of the mold so as to form a complete piece. However, such production gives rise necessarily, in the obtained piece, to a remaining small hole corresponding to the opening for introduction of polymer powder into the mold. The existence of such an opening is unacceptable in the case of certain applications.

There are also other techniques for the production of wheels, namely, for example for trashcan wheels, which are produced by molding in a same mold two half-shells, which are then assembled by welding, by friction or by migration. Such a process for production is at the outset less troublesome, namely as to molding the two half-shells, but the following step of welding greatly increases the cost of such wheels.

Moreover, the production of annular pieces of large cross-section having a completely hollow ring over all its circumference, risks having as a result unacceptable deformations of this ring.

There is also known from JP-A-2002 018906 different processes for gas injection, which are solely applicable to the production of wheels of small diameter.

A fundamental difference between the processes described in this document and the process according to the present invention resides in the use of radii of the pieces to produce to bring the fluid, such as gas, into the rolling strip.

However, in these embodiments, supplying the fluid, such as gas, is carried out by complex means by different points on the wheel rim.

The present invention has for its object to overcome these drawbacks by providing a process for the production of wheels, steering wheels or any other annular pieces, whose wall thickness of the annular portion is relatively small, this production being carried out in a single molding operation.

To this end, the process of production of pieces of synthetic materials with a hollow cross-section, made by preliminary injection of melted synthetic material into a mold, followed by injection of a fluid under pressure adapted to press the melted material against the walls of the mold, whilst terminating filling of the imprint, is characterized in that it consists essentially in carrying out the injection of melted synthetic material, shank or hub, through at least one opening provided in the hub permitting the production of a guidance region for the rotation axle.

The invention also has for its object a piece of hollow annular cross-section of synthetic material, characterized in that it is of one piece construction and has a wall thickness of the hollow annular section that is constant and small.

The invention will be better understood from the following description, which relates to a preferred embodiment, given by way of non-limiting example, and explained with reference to the accompanying schematic drawing, in which:

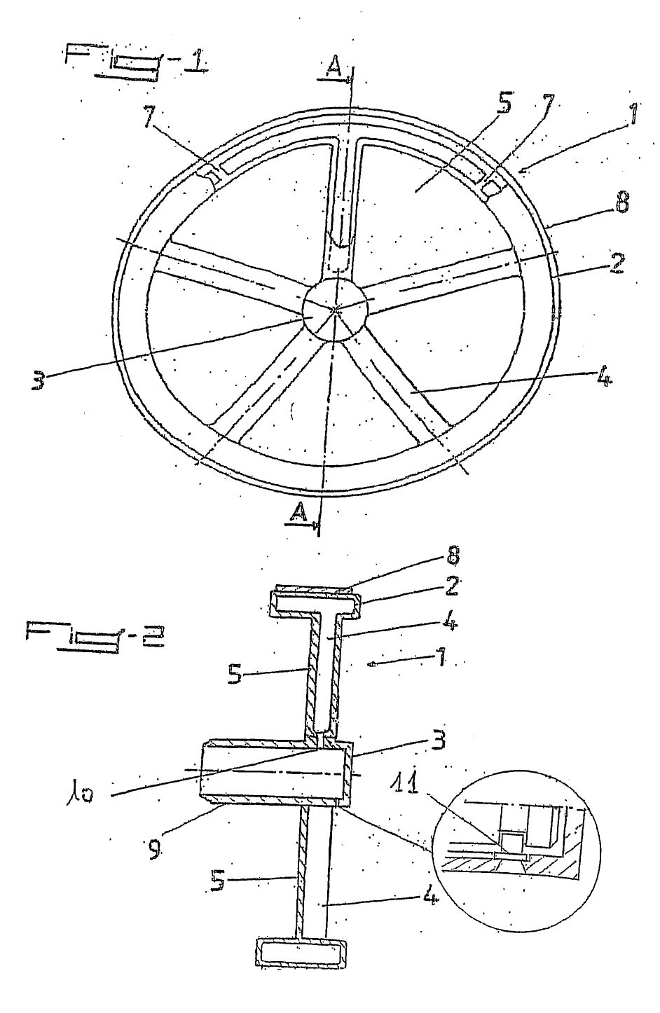

FIG. 1 is a side elevational view partly in cross-section, of a piece of hollow annular cross-section of synthetic material obtained by the practice of the process according to the invention, and

FIG. 2 is a cross-sectional view on the line A-A of FIG. 1.

According to the invention, and as shown more particularly by way of example in FIGS. 1 and 2 of the accompanying drawing, the process for the production of pieces of synthetic material with hollow annular cross-section, carried out by preliminary injection of the melted synthetic material into a mold, followed by the injection of a fluid under pressure adapted to press the melted material against the walls of the mold, whilst terminating the filling of the imprint, is characterized in that it consists essentially in carrying out the injection of melted synthetic material, at the shank or hub 3, by means of an opening provided for this purpose in the mold and in that the injection of a fluid is carried out, adjacent the shank or hub 3, through at least one opening provided in the hub permitting the production of the guidance zone 10 for the rotation axle.

Thus, it is possible to produce a piece 1 comprising a hollow annular cross-section 2 connected to the hub or shank 3 by one or several radii or ribs 4 disposed at regular intervals and integrated or not into a sheet 5.

Preferably, the injection of fluid is carried out through the hub permitting the production of the guidance zone 10 for the rotation axle, the fluid distributing in a balanced manner in each of the preferential directions determined by the ribs or radii 4.

To this end, the piece 1 is provided with ribs or radii 4 for connection of the shank or hub 3 to the annular section 2, disposed at regular intervals or not.

The bubbles formed by injection of fluid through the hub thus carry out an intimate application of the synthetic material against the corresponding walls of the mold, namely those delimiting the ribs or radii 4 and the hollow annular cross-section 2, these bubbles expanding in a perfectly balanced manner in the portion of the mold corresponding to the hollow cross-section 2 by forming, between two bubbles emanating from two different ribs or radii 4, a separation wall 7 (FIG. 1). Thus, it should be recalled that theoretically, two bubbles cannot penetrate each other, such that there necessarily forms between two bubbles deforming a viscous material a wall or partition of material determining the separation walls 7 which constitute a type of reinforcing ribs transverse to the interior of the hollow annular cross-section 2. In practice, it is altogether possible to obtain a single bubble by interpenetration of one bubble into the other. After solidification of the synthetic material constituting the piece 1, in the form of a wheel, a steering wheel or any other piece of this type, the pressure of the fluid is cut off and the conduit connected to the injection hub is emptied, such that the fluid is evacuated from the piece 1 leaving only in this latter veins formed in the material constituting it.

It is also envisageable, in the case of the production of pieces 1 comprising a sheet 5, to delimit in this sheet 5, at regular intervals, a certain number of pockets of fluid by means of the injection hub forming the guidance zone 10 for the axle of rotation and hence produced in this latter. This embodiment is not shown in detail in FIGS. 1 and 2.

The process for production according to the invention thus permits, by suitable dosage of the injection of synthetic material and by injection of fluid through the injection hub, producing wall thicknesses of the ribs or radii and of the annular hollow section that are relatively small, whilst ensuring good rigidity of this latter, which is to say by avoiding its deformation under load. Thus, by way of example, a piece of a diameter of 250 mm comprising a hollow annular cross-section of a height comprised between 18 mm and 24 mm will have a sheet of a thickness of 3 mm and ribs of a width of the order of 12 mm, whilst the thickness of the wall of the hollow annular cross-section will be of the order of 3 to 5 mm.

Of course, the number of radii or ribs 4 provided in the sheet 5 and forming a rigidification support for said sheet 5, as well as the thickness of this latter, are a function of the external dimensions of the piece and of the desired thickness of the hollow annular cross-section. Preferably, the ribs 4 will have a circular cross-section and will thus form a very solid mechanical reinforcement.

According to another characteristic of the invention, the piece of synthetic material thus obtained is provided, by over-molding, with strip of covering 8 of a soft synthetic material, such as synthetic rubber or any other material that can play the same role, namely to form a rolling strip in the case of a wheel, so as to absorb shock and noise connected with rolling of the piece on a support or else, in the case of a steering wheel, to ensure comfort of gripping by the user in a manner agreeable to the touch. In the case of a wheel, the thickness of this strip of covering 8 is comprised between 3 mm and 5 mm. In the case of a steering wheel, it can be reduced.

The invention also has for its object a piece of synthetic material of hollow annular cross-section, which is characterized in that it is of one piece construction and has a hollow annular cross-section 2 provided with hollow sections delimited by transverse walls 7, these hollow sections being each connected to a corresponding hollow section delimited in a rib or radius 4 and/or in a sheet 5.

According to one characteristic of the invention, the piece 1 can be provided, on at least one side of its hub or shank 3, with guide means 9 for snapping into a support. This means 9 can be in the form of a lug that snaps into an opening 11 provided for this purpose in the hub or shank 3. It is thus possible to carry out the axial positioning of the piece 1 along its axis. The hub or shank 3 is thus retained in translation and simultaneously guided in rotation.

The piece 1 according to the invention is more particularly adapted to equip movable items such as urban containers, handling carriages, as well as small operating apparatus such as lawnmowers or else wheels for infant perambulators or wheels of carriages for the transportation of children. This list is however in no way exhaustive.

Thanks to the invention, it is possible to make, by fluid assisted injection, pieces of synthetic material whose annular cross-section is hollow and has walls of small thickness, whilst being sufficiently rigid to resist the loads to which they are normally subjected. As a result, for a same diameter, the pieces thus obtained are lighter and hence require the use of less synthetic material, such that their price will be reduced as a result.

Of course, the invention is not limited to the embodiment described and shown in the accompanying drawing. Modifications remain possible, particularly as to the construction of the various elements or by substitution of technical equivalents, without thereby departing from the scope of the invention.

1. Process for the production of pieces of synthetic material of hollow annular cross-section, made by preliminary injection of melted synthetic material into a mold, followed by the injection of a fluid under pressure adapted to press the molten material against the walls of the mold, whilst terminating the filling of the imprint, characterized in that it consists essentially in carrying out the injection of melted synthetic material at the shank or hub (3), by means of an opening provided for this purpose in the mold and in that the injection of a fluid is carried out, adjacent the shank or hub (3), through at least one opening provided in the hub permitting the production of a zone of guidance (10) for the axle of rotation.

2. Process according to claim 1, characterized in that the injection of fluid is carried out through the hub permitting the production of the zone of guidance (10) for the rotation axle.

3. Process according to claim 1, characterized in that after solidification of the synthetic material constituting the piece (1), the pressure of the fluid is stopped and the conduit connected to the injection hub is emptied, such that said fluid is evacuated from the piece (1) leaving in this latter only veins formed in the material constituting it.

4. Process according to claim 1, characterized in that the bubbles formed by injection of fluid through the hub carry out an intimate application of the synthetic material against the corresponding walls of the mold, namely those delimiting the ribs or radii (4) and/or a sheet (5) and a hollow cross-section (2), these bubbles expanding in a perfectly balanced manner in the portion of the mold corresponding to the hollow annular cross-section (2) and being adapted to form, between two bubbles emanating from two different ribs or radii (4), a separation wall (7).

5. Process according to claim 1, characterized in that in the case of producing pieces (1), comprising a sheet (5), it consists in delimiting in this sheet (5), at regular intervals, a certain number of pockets of fluid by means of the injection hub forming a guidance zone (10) for the rotation axle.

6. Piece of hollow synthetic material, obtained by the practice of the process according to claim 1, characterized in that it is of one piece construction and has a wall thickness of the hollow annular cross-section (2) that is constant and small.

7. Piece according to claim 6, characterized in that it has a hollow annular cross-section (2) provided with hollow sections delimited by transverse walls (7), these hollow sections being each connected to a corresponding hollow section delimited in a rib or radius (4) and/or in the sheet (5).

8. Piece according to claim 7, characterized in that it comprises a hollow annular cross-section (2) connected to its hub or shank (3) by one or several radii or ribs (4) disposed at regular intervals and integrated or not into a sheet (5).

9. Piece according to claim 7, characterized in that it is provided, in the sheet (5), at regular intervals, with a certain number of pockets connected to the guidance region (10) for the rotation axle.

10. Piece according to claim 8, characterized in that the radii or ribs (4) have a circular cross-section.

11. Piece according to claim 6, characterized in that it is provided, by over-molding, with a covering strip (8) of a soft synthetic material, such as synthetic rubber or any other material that can perform the same function.

12. Piece according to claim 8, characterized in that it is provided, on at least one side of its hub or shank (3) with means (9) for guidance and snapping into a support.

13. Piece according to claim 12, characterized in that the means (9) is in the form of a lug that snaps into an opening (11) provided for this purpose in the hub or shank (3).

14. Piece of hollow synthetic material, obtained by the practice of the process according to claim 2, characterized in that it is of one piece construction and has a wall thickness of the hollow annular cross-section (2) that is constant and small.

15. Piece of hollow synthetic material, obtained by the practice of the process according to claim 3, characterized in that it is of one piece construction and has a wall thickness of the hollow annular cross-section (2) that is constant and small.

16. Piece of hollow synthetic material, obtained by the practice of the process according to claim 4, characterized in that it is of one piece construction and has a wall thickness of the hollow annular cross-section (2) that is constant and small.

17. Piece of hollow synthetic material, obtained by the practice of the process according to claim 5, characterized in that it is of one piece construction and has a wall thickness of the hollow annular cross-section (2) that is constant and small.
